(19) United States
(12) Patent Application Publication
(10) Pub. No.: US 2025/0260423 A1
(43) Pub. Date: Aug. 14, 2025

(54) RADIO FREQUENCY CIRCUIT

(71) Applicant: Murata Manufacturing Co., Ltd., Nagaokakyo-shi (JP)

(72) Inventors: Hirotsugu MORI, Nagaokakyo-shi (JP); Morio TAKEUCHI, Nagaokakyo-shi (JP)

(73) Assignee: Murata Manufacturing Co., Ltd., Nagaokakyo-shi (JP)

(21) Appl. No.: 19/174,170

(22) Filed: Apr. 9, 2025

Related U.S. Application Data
(63) Continuation of application No. PCT/JP2023/027630, filed on Jul. 27, 2023.

(30) Foreign Application Priority Data
Oct. 12, 2022 (JP) 2022-164115

(51) Int. Cl. H04B 1/00; H04B 1/04

(52) U.S. Cl. CPC H04B 1/006; H04B 1/001; H04B 1/0483

(57) ABSTRACT

A radio frequency circuit includes: a first filter having a passband that includes a downlink band of a first band and a downlink band of a second band; a second filter having a passband that includes the downlink band of the first band and a downlink band of a third band; and a first switch that includes a first terminal connected to an antenna connection terminal, a second terminal connected to the first filter, and a third terminal connected to the second filter. The downlink band of the first band, the downlink band of the second band, and the downlink band of the third band at least partially overlap one another, and a combination of the first band and the second band and a combination of the first band and the third band are included in predefined band combinations for simultaneous communication.

### CROSS-REFERENCE TO RELATED APPLICATIONS

This is a continuation application of PCT International Application No. PCT/JP2023/027630 filed on Jul. 27, 2023, designating the United States of America, which is based on and claims priority to Japanese Patent Application No. 2022-164115 filed on Oct. 12, 2022. The entire disclosures of the above-identified applications, including the specifications, drawings and claims are incorporated herein by reference in their entirety.

### TECHNICAL FIELD

The present disclosure relates to a radio frequency circuit.

### BACKGROUND

In mobile communication devices such as mobile phones, technology for simultaneously receiving, transmitting, or transmitting and receiving radio frequency signals in a plurality of communication systems and/or a plurality of bands has been more progressively supported. For example, the 3rd Generation Partnership Project (3GPP (registered trademark)) has defined carrier aggregation and dual connectivity, for instance. US Patent Application Publication No. 2015/0133067 discloses a radio frequency circuit for carrier aggregation.

### SUMMARY

### Technical Problems

However, as recognized by the present inventor, with the above conventional technique, a radio frequency circuit may become complicated in order to achieve simultaneous communication in a plurality of band combinations, resulting in an increase in the size of a communication device.

In view of this, the present disclosure provides a radio frequency circuit that can contribute to reduction in the size of a communication device that can perform simultaneous communication in a plurality of band combinations.

### Solutions

A radio frequency circuit according to an aspect of the present disclosure includes: a first filter having a passband that includes a downlink band of a first band and a downlink band of a second band; a second filter having a passband that includes the downlink band of the first band and a downlink band of a third band; and a first switch that includes a first terminal connected to an antenna connection terminal, a second terminal connected to the first filter, and a third terminal connected to the second filter. The downlink band of the first band, the downlink band of the second band, and the downlink band of the third band at least partially overlap one another, and a combination of the first band and the second band is included in a first predefined band combination for simultaneous communication, and a combination of the first band and the third band is included in a second predefined band combination for simultaneous communication.

A radio frequency circuit according to an aspect of the present embodiment includes: a first filter having a passband that includes a downlink band of n256 for 5th Generation New Radio (5G NR) and a downlink band of Band 1 for Long Term Evolution (LTE) or n1 for 5G NR; a second filter having a passband that includes the downlink band of n256 for 5G NR and a downlink band of Band 66 for LTE or n66 for 5G NR; a third filter having a passband that includes a downlink band of Band 3 for LTE or n3 for 5G NR; a fourth filter having a passband that includes a downlink band of Band 2 for LTE or n2 for 5G NR and an uplink band of n256 for 5G NR; a fifth filter having a passband that includes the uplink band of n256 for 5G NR and an uplink band of Band 1 for LTE or n1 for 5G NR; a sixth filter having a passband that includes an uplink band of Band 3 for LTE or n3 for 5G NR; a seventh filter having a passband that includes an uplink band of Band 66 for LTE or n66 for 5G NR; an eighth filter having a passband that includes an uplink band of Band 2 for LTE or n2 for 5G NR; and a first switch that includes a first terminal connected to an antenna connection terminal, a second terminal connected to the first filter, the third filter, the fifth filter, and the sixth filter, and a third terminal connected to the second filter, the fourth filter, the seventh filter, and the eighth filter.

### Advantageous Effects

A radio frequency circuit according to an aspect of the present disclosure can contribute to reduction in the size of a communication device that can perform simultaneous communication in a plurality of band combinations.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a circuit configuration of a communication device according to an embodiment.

FIG. 2 illustrates frequency bands used in the embodiment.

FIG. 3 illustrates a circuit configuration showing a connected state for simultaneous communication in Bands B and D in the embodiment.

FIG. 4 illustrates a circuit configuration showing a connected state for simultaneous communication in Bands A and B in the embodiment.

FIG. 5 illustrates a circuit configuration showing a connected state for simultaneous communication in Bands C and E in the embodiment.

FIG. 6 illustrates a circuit configuration showing a connected state for simultaneous communication in Bands A and C in the embodiment.

### DESCRIPTION OF EMBODIMENTS

The following describes in detail embodiments of the present disclosure, with reference to the drawings. Note that the embodiments described below each show a general or specific example. The numerical values, shapes, materials, elements, and the arrangement and connection of the elements, for instance, described in the following embodiments are examples, and thus are not intended to limit the present disclosure.

Note that the drawings are schematic diagrams to which emphasis, omission, and ratio adjustment are appropriately added in order to illustrate the salient features of the present disclosure, and thus are not necessarily accurate or complete illustrations with respect to a commercial product. For example, he drawings may show shapes, positional relations, and ratios that are different from actual shapes, actual positional relations, and actual ratios. Throughout the drawings, the same numeral is given to substantially the same element, and redundant description may be omitted or simplified.

In the circuit configuration of the present disclosure, “being connected” includes not only the case of being directly connected by a connection terminal and/or a line conductor, but also the case of being electrically connected via another circuit element. “Being connected between A and B” means being connected between A and B and to both A and B, and means being connected in series onto a path that connects A and B. A “terminal” means a point at which a conductor in an element ends. Note that under a condition that an impedance of a conductor between elements is sufficiently low, a terminal may be interpreted not only as a single fixed point, but as any point on the conductor between the elements or as the entire conductor.

In the present disclosure, “at least partially overlap each other” in a plurality of bands means that the plurality of bands each have an overlapping portion that overlaps at least one of the remaining other bands. At this time, the overlapping portion may be only a band edge. For example, in two bands, “at least partially overlap each other” includes not only the highest frequency of the lower band (or stated differently, the high-frequency edge of the lower band) being higher than the lowest frequency in the higher band (or stated differently, the low-frequency edge of the higher band), but also the high-frequency edge of the lower band matching the low-frequency edge of the higher band.

In the present disclosure, a “downlink band” is a downlink operating band, and means a portion of a communication band that is designated for downlink communication. Thus, a “downlink band” means a band that is utilized to transfer radio frequency signals from a base station (BS) to a user equipment (UE) in frequency division duplex (FDD).

In contrast, an “uplink band” is an uplink operating band, and means a portion of a communication band that is designated for uplink communication. Thus, an “uplink band” means a band that is utilized to transfer radio frequency signals from a UE to a BS in FDD.

Furthermore, “a passband of a filter” is a portion of a frequency spectrum of a signal transferred by a filter and is defined as a frequency band in which an output power is not attenuated from a maximum output power by 3 dB or more. Thus, a high-frequency edge and a low-frequency edge of a passband of a bandpass filter are identified as a higher frequency and a lower frequency at two points at which an output power is attenuated from a maximum output power by 3 dB.

### Embodiment

Communication device 5 according to the present embodiment functions as a user equipment (UE) in a cellular network, and typically is a mobile phone, a smartphone, a tablet computer, or a wearable device, for instance. Note that communication device 5 may be an Internet of Things (IoT) sensor/device, a medical/health care device, a vehicle, an unmanned aerial vehicle (UAV) (a so-called drone), or an automated guided vehicle (AGV). Furthermore, communication device 5 may function as a base station (BS) in the cellular network.

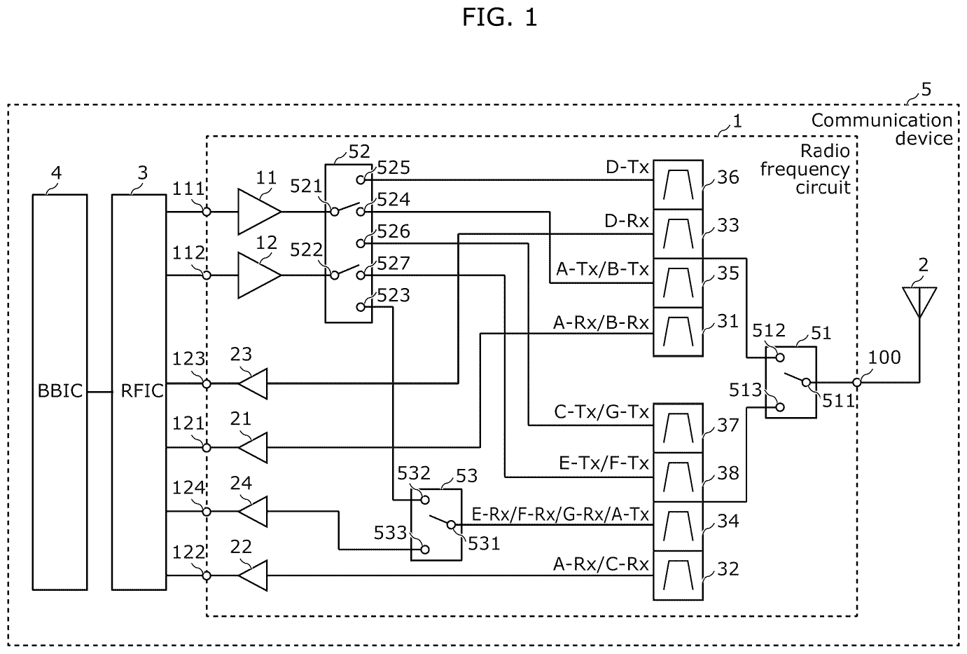

A circuit configuration of communication device 5 and radio frequency circuit 1 according to the present embodiment is to be described with reference to FIG. 1. FIG. 1 illustrates a circuit configuration of communication device 5 according to the present embodiment.

Note that FIG. 1 illustrates an exemplary circuit configuration, and communication device 5 and radio frequency circuit 1 may be implemented using any of various types of circuit implementations and circuit technologies. Thus, the description of communication device 5 and radio frequency circuit 1 provided below should not be interpreted in a limited manner.

### [1.1 Circuit Configuration of Communication Device 5]

First, a circuit configuration of communication device 5 according to the present embodiment is to be described with reference to FIG. 1. Communication device 5 includes radio frequency circuit 1, antenna 2, radio frequency integrated circuit (RFIC) 3, and baseband integrated circuit (BBIC) 4.

Radio frequency circuit 1 transfers radio frequency signals between antenna 2 and RFIC 3. A circuit configuration of radio frequency circuit 1 is to be described later.

Antenna 2 is connected to antenna connection terminal 100 of radio frequency circuit 1. Antenna 2 receives radio frequency signals from radio frequency circuit 1 and outputs the radio frequency signals to the outside of communication device 5. Antenna 2 receives radio frequency signals from the outside of communication device 5 and outputs the radio frequency signals to radio frequency circuit 1. Note that antenna 2 may not be included in communication device 5. Communication device 5 may further include one or more antennas in addition to antenna 2.

RFIC 3 is an example of a signal processing circuit that processes radio frequency signals. Specifically, RFIC 3 processes transmission signals input from BBIC 4 by, for instance, up-conversion, and outputs radio frequency transmission signals generated by processing the transmission signals to radio frequency circuit 1. Furthermore, RFIC 3 processes radio frequency received signals input through a reception path of radio frequency circuit 1 by down-conversion, for instance, and outputs received signals generated by processing the radio frequency received signals to BBIC 4. RFIC 3 may include a controller (e.g., programmable circuitry such as a CPU that is configured to perform control operations by the circuitry's execution of stored computer code) configured to control, for instance, a switch and a power amplifier that are included in radio frequency circuit 1. Note that the controller may be partially or entirely provided outside of RFIC 3, and may be partially or entirely provided in BBIC 4 or radio frequency circuit 1, for example.

BBIC 4 is a base band signal processing circuit that processes signals using an intermediate frequency band lower than a frequency of a radio frequency signal transferred by radio frequency circuit 1. A signal processed by BBIC 4 is used, for example, as an image signal for image display or as an audio signal for voice through a loudspeaker. Note that BBIC 4 need not be included in communication device 5.

### [1.2 Circuit Configuration of Radio Frequency Circuit 1]

Next, a circuit configuration of radio frequency circuit 1 according to the present embodiment is described with reference to FIG. 1. Radio frequency circuit 1 includes power amplifiers 11 and 12, low-noise amplifiers 21 to 24, filters 31 to 38, switches 51 to 53, antenna connection terminal 100, radio frequency input terminals 111 and 112, and radio frequency output terminals 121 to 124.

Antenna connection terminal 100 is an external connection terminal of radio frequency circuit 1. Specifically, antenna connection terminal 100 is connected to antenna 2 outside radio frequency circuit 1 and is connected to switch 51 inside radio frequency circuit 1. Accordingly, radio frequency circuit 1 can supply transmission signals to antenna 2 via antenna connection terminal 100, and can be supplied with received signals from antenna 2 via antenna connection terminal 100.

Radio frequency input terminals 111 and 112 are external connection terminals of radio frequency circuit 1. Specifically, radio frequency input terminal 111 is connected to RFIC 3 outside radio frequency circuit 1 and is connected to power amplifier 11 inside radio frequency circuit 1. Radio frequency input terminal 112 is connected to RFIC 3 outside radio frequency circuit 1 and is connected to power amplifier 12 inside radio frequency circuit 1. Radio frequency input terminals 111 and 112 can receive transmission signals in Bands A to G from RFIC 3.

Power amplifier 11 is an example of a first power amplifier. The input end of power amplifier 11 is connected to radio frequency input terminal 111. The output end of power amplifier 11 is connected to filters 34 to 38 via switch 52. Power amplifier 11 can amplify radio frequency signals received via radio frequency input terminal 111, using power supplied from a power supply (not illustrated).

Power amplifier 12 is an example of a second power amplifier. The input end of power amplifier 12 is connected to radio frequency input terminal 112. The output end of power amplifier 12 is connected to filters 34 to 38 via switch 52. Power amplifier 12 can amplify radio frequency signals received via radio frequency input terminal 112, using power supplied from a power supply (not illustrated).

Power amplifiers 11 and 12 can include heterojunction bipolar transistors (HBTs), and can be manufactured using semiconductor material. As the semiconductor material, silicon-germanium (SiGe) or gallium arsenide (GaAs) can be used, for example. Note that amplifier transistors of power amplifiers 11 and 12 are not limited to HBTs. For example, at least one of power amplifier 11 or power amplifier 12 may include a high electron mobility transistor (HEMT) or a metal-semiconductor field effect transistor (MESFET). In this case, gallium nitride (GaN) or silicon carbide (SiC) may be used as the semiconductor material.

Note that power amplifier 11 and/or power amplifier 12 may not be partially or entirely included in radio frequency circuit 1. In this case, power amplifier 11 may be connected between RFIC 3 and radio frequency input terminal 111, and power amplifier 12 may be connected between RFIC 3 and radio frequency input terminal 112. Power amplifier 11 and/or power amplifier 12 may be partially or entirely included in RFIC 3.

Low-noise amplifier 21 is an example of a first low-noise amplifier. The input end of low-noise amplifier 21 is connected to filter 31. The output end of low-noise amplifier 21 is connected to radio frequency output terminal 121. Low-noise amplifier 21 can amplify received signals in Bands A and B that have passed through filter 31, by using power supplied from a power source (not illustrated).

Low-noise amplifier 22 is an example of a second low-noise amplifier. The input end of low-noise amplifier 22 is connected to filter 32. The output end of low-noise amplifier 22 is connected to radio frequency output terminal 122. Low-noise amplifier 22 can amplify received signals in Bands A and C that have passed through filter 32, by using power supplied from the power source (not illustrated).

Low-noise amplifier 23 is an example of a third low-noise amplifier. The input end of low-noise amplifier 23 is connected to filter 33. The output end of low-noise amplifier 23 is connected to radio frequency output terminal 123. Low-noise amplifier 23 can amplify received signals in Band D that have passed through filter 33, by using power supplied from the power source (not illustrated).

Low-noise amplifier 24 is an example of a fourth low-noise amplifier. The input end of low-noise amplifier 24 is connected to filter 34 via switch 53. The output end of low-noise amplifier 24 is connected to radio frequency output terminal 124. Low-noise amplifier 24 can amplify received signals in Bands E to G that have passed through filter 34, by using power supplied from the power source (not illustrated).

Low-noise amplifiers 21 to 24 can include field effect transistors (FETs), and can be manufactured using semiconductor material. As the semiconductor material, for example, monocrystal silicon, gallium nitride (GaN), or silicon carbide (SIC) can be used. Note that amplifier transistors of low-noise amplifiers 21 to 24 are not limited to FETs. For example, one or more or all of low-noise amplifiers 21 to 24 may each include a bipolar transistor.

Note that one or more or all of low-noise amplifiers 21 to 24 may not be partially or entirely included in radio frequency circuit 1. In this case, low-noise amplifier 21 may be connected between radio frequency output terminal 121 and RFIC 3, low-noise amplifier 22 may be connected between radio frequency output terminal 122 and RFIC 3, low-noise amplifier 23 may be connected between radio frequency output terminal 123 and RFIC 3, and low-noise amplifier 24 may be connected between radio frequency output terminal 124 and RFIC 3. One or more or all of low-noise amplifiers 21 to 24 may be partially or entirely included in RFIC 3.

Filter 31 (A-Rx/B-Rx) is an example of a first filter, and is a band-pass filter having a passband that includes downlink bands of Bands A and B. Filter 31 is connected between switch 51 and radio frequency output terminal 121. Specifically, one end of filter 31 is connected to terminal 512 of switch 51, and another end of filter 31 is connected to the input end of low-noise amplifier 21.

Filter 32 (A-Rx/C-Rx) is an example of a second filter, and is a band-pass filter having a passband that includes downlink bands of Bands A and C. Filter 32 is connected between switch 51 and radio frequency output terminal 122. Specifically, one end of filter 32 is connected to terminal 513 of switch 51, and another end of filter 32 is connected to the input end of low-noise amplifier 22.

Filter 33 (D-Rx) is an example of a third filter, and is a band-pass filter having a passband that includes a downlink band of Band D. Filter 33 is connected between switch 51 and radio frequency output terminal 123. Specifically, one end of filter 33 is connected to terminal 512 of switch 51, and another end of filter 33 is connected to the input end of low-noise amplifier 23. Note that filter 33 may not be included in radio frequency circuit 1.

Filter 34 (E-Rx/F-Rx/G-Rx/A-Tx) is an example of a fourth filter, and is a band-pass filter having a passband that includes downlink bands of Bands E, F, and G and an uplink band of Band A. Filter 34 is connected between (i) switch 51 and (ii) radio frequency output terminal 124 and radio frequency input terminal 111 and/or radio frequency input terminal 112. Specifically, one end of filter 34 is connected to terminal 513 of switch 51, and another end of filter 34 is connected to terminal 531 of switch 53. Note that filter 34 may not be included in radio frequency circuit 1. The passband of filter 34 may not include downlink bands of Bands F and G.

Filter 35 (A-Tx/B-Tx) is an example of a fifth filter, and is a band-pass filter having a passband that includes uplink bands of Bands A and B. Filter 35 is connected between (i) switch 51 and (ii) radio frequency input terminal 111 and/or radio frequency input terminal 112. Specifically, one end of filter 35 is connected to terminal 512 of switch 51, and another end of filter 35 is connected to terminal 524 of switch 52. Note that filter 35 may not be included in radio frequency circuit 1. Filter 35 may be connected to an additional terminal (not illustrated) of switch 51.

Filter 36 (D-Tx) is an example of a sixth filter, and is a band-pass filter having a passband that includes an uplink band of Band D. Filter 36 is connected between (i) switch 51 and (ii) radio frequency input terminal 111 and/or radio frequency input terminal 112. Specifically, one end of filter 36 is connected to terminal 512 of switch 51, and another end of filter 36 is connected to terminal 525 of switch 52. Note that filter 36 may not be included in radio frequency circuit 1. The passband of filter 36 may include an uplink band of Band C. Furthermore, filter 36 may be connected to an additional terminal (not illustrated) of switch 51.

Filter 37 (C-Tx/G-Tx) is an example of a seventh filter, and is a band-pass filter having a passband that includes uplink bands of Bands C and G. Filter 37 is connected between (i) switch 51 and (ii) radio frequency input terminal 111 and/or radio frequency input terminal 112. Specifically, one end of filter 37 is connected to terminal 513 of switch 51, and another end of filter 37 is connected to terminal 526 of switch 52. Note that filter 37 may not be included in radio frequency circuit 1. The passband of filter 37 may not include an uplink band of Band G.

Filter 38 (E-Tx/F-Tx) is an example of an eighth filter, and is a band-pass filter having a passband that includes uplink bands of Bands E and F. Filter 38 is connected between (i) switch 51 and (ii) radio frequency input terminal 111 and/or radio frequency input terminal 112. Specifically, one end of filter 38 is connected to terminal 513 of switch 51, and another end of filter 38 is connected to terminal 527 of switch 52. Note that filter 38 may not be included in radio frequency circuit 1. The passband of filter 38 may not include an uplink band of Band F.

A surface acoustic wave (SAW) filter, a bulk acoustic wave (BAW) filter, an inductor-capacitor (LC) resonator filter, a dielectric resonator filter, or a combination of any of these may be used as each of such filters 31 to 38, and furthermore, filters 31 to 38 are not limited to these.

Switch 51 is an example of a first switch, and is connected between antenna connection terminal 100 and filters 31 to 38. Specifically, switch 51 includes terminals 511 to 513. Terminal 511 is an example of a first terminal, and is connected to antenna connection terminal 100. Terminal 512 is an example of a second terminal, and is connected to filters 31, 33, 35, and 36. Terminal 513 is an example of a third terminal, and is connected to filters 32, 34, 37, and 38.

With such a connection configuration, switch 51 can connect terminal 511 exclusively to terminal 512 or can connect terminal 511 exclusively to terminal 513, based on a control signal from RFIC 3, for example. Stated differently, terminal 511 is prohibited from being simultaneously connected to terminals 512 and 513 in switch 51. Switch 51 includes a single-pole double-throw (SPDT) switch circuit, for example.

Switch 52 is an example of a second switch, and is connected between filters 34 to 38 and power amplifiers 11 and 12. Specifically, switch 52 includes terminals 521 to 527. Terminal 521 is an example of a fourth terminal, and is connected to the output end of power amplifier 11. Terminal 522 is an example of a fifth terminal, and is connected to the output end of power amplifier 12. Terminal 523 is an example of a sixth terminal, and is connected to terminal 532 of switch 53. Terminal 524 is an example of a seventh terminal, and is connected to filter 35. Terminal 525 is an example of an eighth terminal, and is connected to filter 36. Terminal 526 is an example of a ninth terminal, and is connected to filter 37. Terminal 527 is an example of a tenth terminal, and is connected to filter 38.

With this connection configuration, switch 52 can connect terminals 521 and 522 to any two terminals among terminals 523 to 527, based on a control signal from RFIC 3, for example. Switch 52 can connect just one of terminal 521 or 522 to terminals 523 to 527 selectively.

Switch 53 is an example of a third switch, and is connected between (i) filter 34 and (ii) low-noise amplifier 24 and power amplifier 11 and/or power amplifier 12. Specifically, switch 53 includes terminals 531 to 533. Terminal 531 is an example of an eleventh terminal and is connected to filter 34. Terminal 532 is an example of a twelfth terminal, and is connected to terminal 523 of switch 52. Terminal 533 is an example of a thirteenth terminal, and is connected to the input end of low-noise amplifier 24.

With this connection configuration, switch 53 can connect terminal 531 exclusively to terminal 532 or can connect terminal 531 exclusively to terminal 533, based on a control signal from RFIC 3, for example. Stated differently, terminal 531 is prohibited from being simultaneously connected to terminals 532 and 533 in switch 53. Switch 53 includes an SPDT switch circuit, for example.

### [1.3 Description of Frequency Bands]

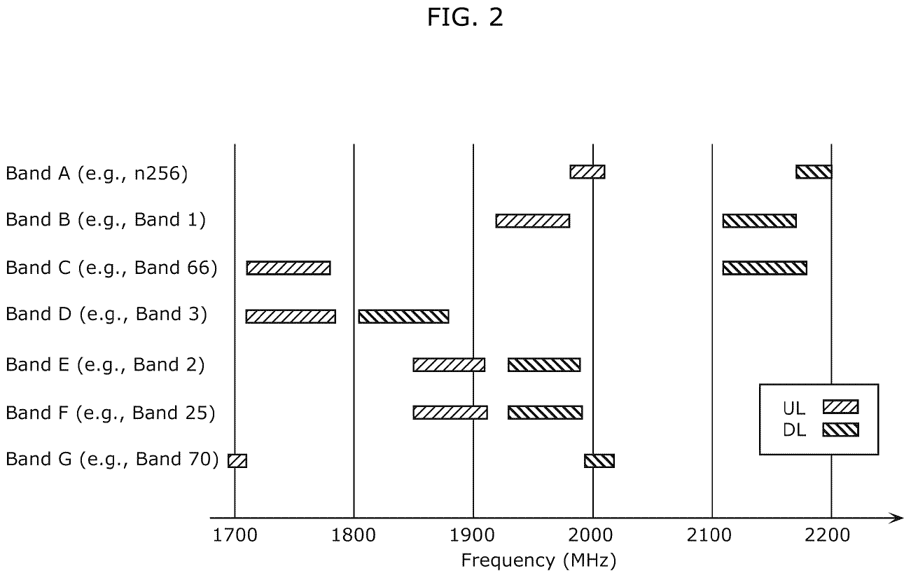

Here, frequency bands used in the present embodiment are to be described with reference to FIG. 2. FIG. 2 illustrates frequency bands used in the present embodiment. In FIG. 2, the vertical axis shows band names, and the horizontal axis shows frequencies (MHz).

Bands A to G are frequency bands for a communication system established using radio access technology (RAT), and are defined in advance by, for instance, standardizing bodies (such as for example, the 3rd Generation Partnership Project (3GPP (registered trademark)) and the Institute of Electrical and Electronics Engineers (IEEE), for example). Examples of the communication system include a 5th Generation New Radio (5G NR) system, a Long Term Evolution (LTE) system, and a Wireless Local Area Network (WLAN) system.

Band A is an example of a first band and is an FDD band that includes an uplink band and a downlink band. The downlink band of Band A at least partially overlaps the downlink bands of Bands B and C. The uplink band of Band A at least partially overlaps the uplink band of Band B and at least partially overlaps the downlink bands of Bands E to G. As Band A, n256 for 5G NR (UL: 1980 MHz to 2010 MHz, DL: 2170 MHz to 2200 MHZ) can be used, for example, but Band A is not limited thereto.

Band B is an example of a second band and is an FDD band that includes an uplink band and a downlink band. The downlink band of Band B at least partially overlaps the downlink bands of Bands A and C. The uplink band of Band B at least partially overlaps the uplink band of Band A and at least partially overlaps the downlink bands of Bands E and F. As Band B, Band 1 for LTE or n1 for 5G NR (UL: 1920 MHz to 1980 MHz, DL: 2110 MHz to 2170 MHz) can be used, for example, but Band B is not limited thereto.

Band C is an example of a third band and is an FDD band that includes an uplink band and a downlink band. The downlink band of Band C at least partially overlaps the downlink bands of Bands A and B. The uplink band of Band C at least partially overlaps the uplink band of Band D. As Band C, Band 66 for LTE or n66 for 5G NR (UL: 1710 MHz to 1780 MHZ, DL: 2110 MHz to 2170 MHz) can be used, for example, but Band C is not limited thereto.

Band D is an example of a fourth band and is an FDD band that includes an uplink band and a downlink band. The downlink band of Band D at least partially overlaps the uplink bands of Bands E and F. The uplink band of Band D at least partially overlaps the uplink band of Band C. As Band D, Band 3 for LTE or n3 for 5G NR (UL: 1710 MHZ to 1785 MHZ, DL: 1805 MHz to 1880 MHZ) can be used, for example, but Band D is not limited thereto.

Band E is an example of a fifth band and is an FDD band that includes an uplink band and a downlink band. The downlink band of Band E at least partially overlaps the downlink band of Band F and at least partially overlaps the uplink bands of Bands A and B. The uplink band of Band E at least partially overlaps the uplink band of Band F and at least partially overlaps the downlink band of Band D. As Band E, Band 2 for LTE or n2 for 5G NR (UL: 1850 MHz to 1910 MHZ, DL: 1930 MHz to 1990 MHz) can be used, for example, but Band E is not limited thereto.

Band F is an example of a sixth band and is an FDD band that includes an uplink band and a downlink band. The downlink band of Band F at least partially overlaps the downlink band of Band E and at least partially overlaps the uplink bands of Bands A and B. The uplink band of Band F at least partially overlaps the uplink band of Band E and at least partially overlaps the downlink band of Band D. As Band F, Band 25 for LTE or n25 for 5G NR (UL: 1850 MHz to 1915 MHz, DL: 1930 MHz to 1995 MHZ) can be used, for example, but Band F is not limited thereto.

Band G is an example of a seventh band and is an FDD band that includes an uplink band and a downlink band. The downlink band of Band G at least partially overlaps the downlink band of Band F and at least partially overlaps the uplink band of Band A. The uplink band of Band G at least partially overlaps the uplink bands of Bands C and D. As Band G, Band 70 for LTE or n70 for 5G NR (UL: 1695 MHz to 1710 MHZ, DL: 1995 MHz to 2020 MHZ) can be used, for example, but Band G is not limited thereto.

For Bands A to G, at least band combinations as shown in Table 1 below are defined in advance by, for instance, the standardizing bodies, as band combinations for simultaneous communication.

TABLE 1

| No. | Band name (1) | Band name (2) |
|---|---|---|
| 1 | Band B | Band D |
| 2 | Band A | Band B |
| 3 | Band C | Band E |
| 4 | Band A | Band C |
| 5 | Band C | Band F |
| 6 | Band C | Band G |

On the other hand, a combination of Bands A and E, a combination of Bands A and F, and a combination of Bands A and G are not defined as band combinations for simultaneous communication. Thus, a signal in Band A is prohibited from being transmitted or received simultaneously with signals in Bands E, F, and G.

### [1.4 Connected States of Radio Frequency Circuit 1]

Next, connected states of radio frequency circuit 1 for simultaneous communication in band combinations 1 to 4 in Table 1 and flows of radio frequency signals are to be described.

### [1.4.1 Connected State for Simultaneous Communication in Bands B and D]

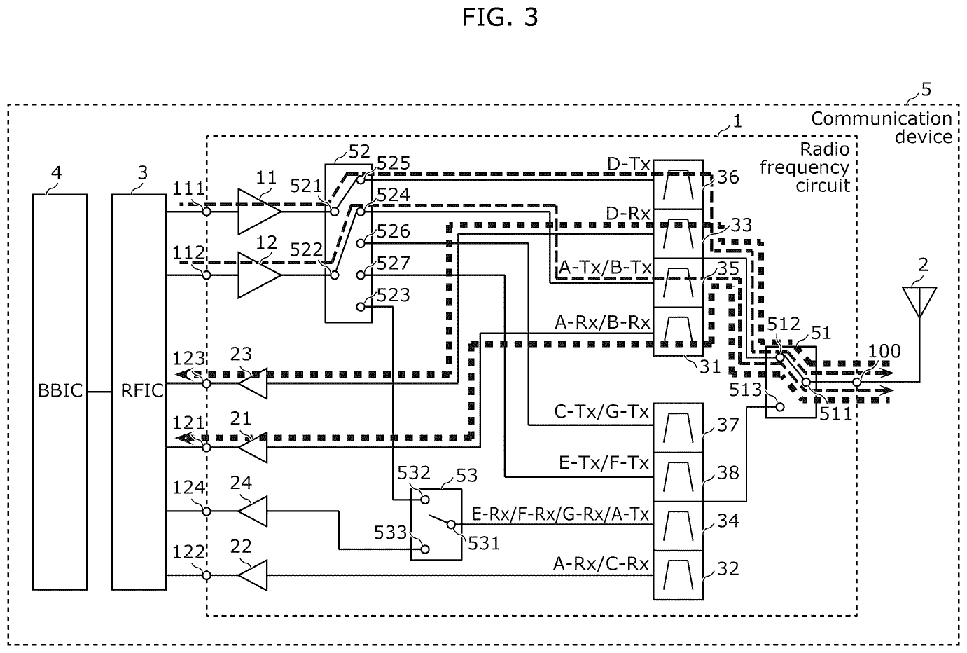

First, simultaneous communication in Band Combination 1 of Bands B and D is to be described with reference to FIG. 3. FIG. 3 illustrates a circuit configuration showing a connected state for simultaneous communication in Bands B and D in the present embodiment. In FIG. 3, broken line arrows show flows of radio frequency signals.

In the connected state in FIG. 3, switch 51 connects terminal 511 to terminal 512 and not to terminal 513. Furthermore, switch 52 connects terminal 521 to terminal 525 and connects terminal 522 to terminal 524. Accordingly, filters 31, 33, and 35 are connected to antenna connection terminal 100, and filters 35 and 36 are connected to power amplifiers 12 and 11.

As a result, a received signal in Band B is transferred from antenna 2 to RFIC 3 via antenna connection terminal 100, switch 51, filter 31, low-noise amplifier 21, and radio frequency output terminal 121. A received signal in Band D is transferred from antenna 2 to RFIC 3 via antenna connection terminal 100, switch 51, filter 33, low-noise amplifier 23, and radio frequency output terminal 123. A transmission signal in Band B is transferred from RFIC 3 to antenna 2 via radio frequency input terminal 112, power amplifier 12, switch 52, filter 35, switch 51, and antenna connection terminal 100. A transmission signal in Band D is transferred from RFIC 3 to antenna 2 via radio frequency input terminal 111, power amplifier 11, switch 52, filter 36, switch 51, and antenna connection terminal 100.

At this time, filter 34 having a passband that includes the downlink bands of Bands E and F that at least partially overlap the uplink band of Band B is connected to terminal 513 of switch 51, and thus is not connected to antenna connection terminal 100. Accordingly, a transmission signal in Band B can be prevented from passing through filter 34.

### [1.4.2 Connected State for Simultaneous Communication in Bands A and B]

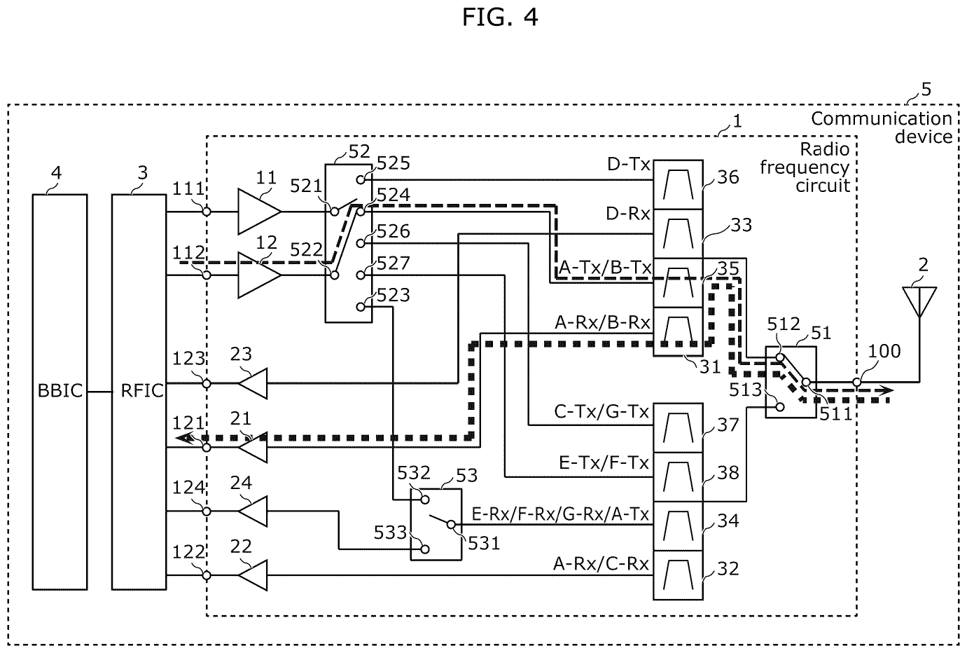

First, simultaneous communication in Band Combination 2 of Bands A and B is to be described with reference to FIG. 4. FIG. 4 illustrates a circuit configuration showing a connected state for simultaneous communication in Bands A and B in the present embodiment. In FIG. 4, broken line arrows show flows of radio frequency signals.

In the connected state in FIG. 4, switch 51 connects terminal 511 to terminal 512 and not to terminal 513. Furthermore, switch 52 connects terminal 522 to terminal 524. Accordingly, filters 31 and 35 are connected to antenna connection terminal 100, and filter 35 is connected to power amplifier 12.

As a result, received signals in Bands A and B are transferred from antenna 2 to RFIC 3 via antenna connection terminal 100, switch 51, filter 31, low-noise amplifier 21, and radio frequency output terminal 121. Transmission signals in Bands A and B are transferred from RFIC 3 to antenna 2 via radio frequency input terminal 112, power amplifier 12, switch 52, filter 35, switch 51, and antenna connection terminal 100.

At this time, similarly to FIG. 3, filter 34 is not connected to antenna connection terminal 100. Thus, a transmission signal in Band B can be prevented from passing through filter 34.

### [1.4.3 Connected State for Simultaneous Communication in Bands C and E]

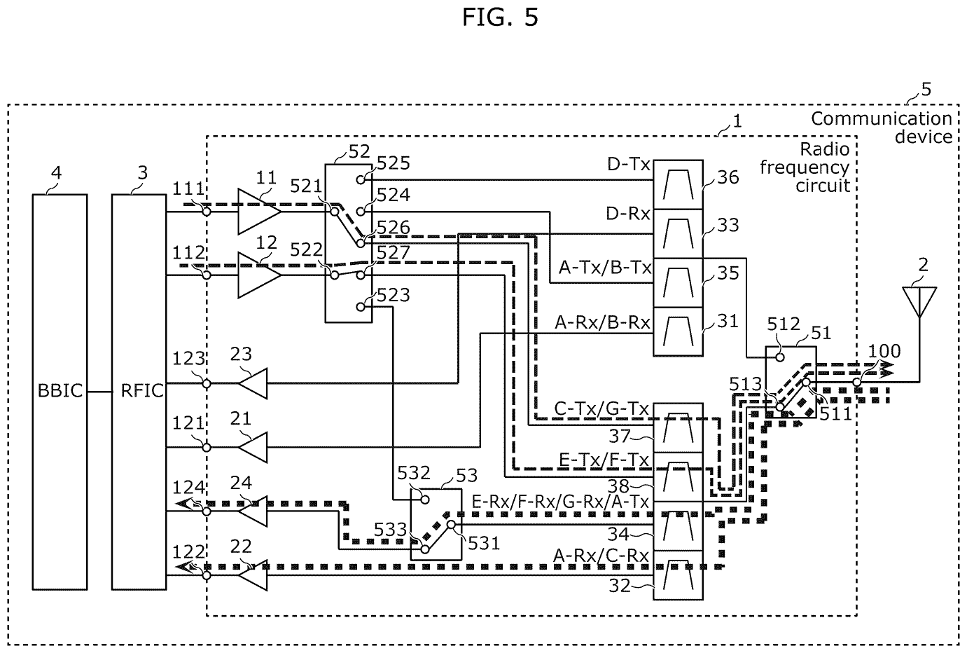

First, simultaneous communication in Band Combination 3 of Bands C and E is to be described with reference to FIG. 5. FIG. 5 illustrates a circuit configuration showing a connected state for simultaneous communication in Bands C and E in the present embodiment. In FIG. 5, broken line arrows show flows of radio frequency signals.

In the connected state in FIG. 5, switch 51 connects terminal 511 to terminal 513 and not to terminal 512. Switch 52 connects terminal 521 to terminal 526 and connects terminal 522 to terminal 527. Furthermore, switch 53 connects terminal 531 to terminal 533. Accordingly, filters 32, 34, 37, and 38 are connected to antenna connection terminal 100, and filter 34 is connected to low-noise amplifier 24, and filters 37 and 38 are connected to power amplifiers 11 and 12, respectively.

As a result, a received signal in Band C is transferred from antenna 2 to RFIC 3 via antenna connection terminal 100, switch 51, filter 32, low-noise amplifier 22, and radio frequency output terminal 122. A received signal in Band E is transferred from antenna 2 to RFIC 3 via antenna connection terminal 100, switch 51, filter 34, switch 53, low-noise amplifier 24, and radio frequency output terminal 124. A transmission signal in Band C is transferred from RFIC 3 to antenna 2 via radio frequency input terminal 111, power amplifier 11, switch 52, filter 37, switch 51, and antenna connection terminal 100. A transmission signal in Band E is transferred from RFIC 3 to antenna 2 via radio frequency input terminal 112, power amplifier 12, switch 52, filter 38, switch 51, and antenna connection terminal 100.

At this time, filter 35 having a passband that includes the uplink band of Band B that at least partially overlaps the downlink band of Band E is connected to terminal 512 of switch 51, and thus is not connected to antenna connection terminal 100. Accordingly, a received signal in Band E can be prevented from passing through filter 35.

### [1.4.4 Connected State for Simultaneous Communication in Bands A and C]

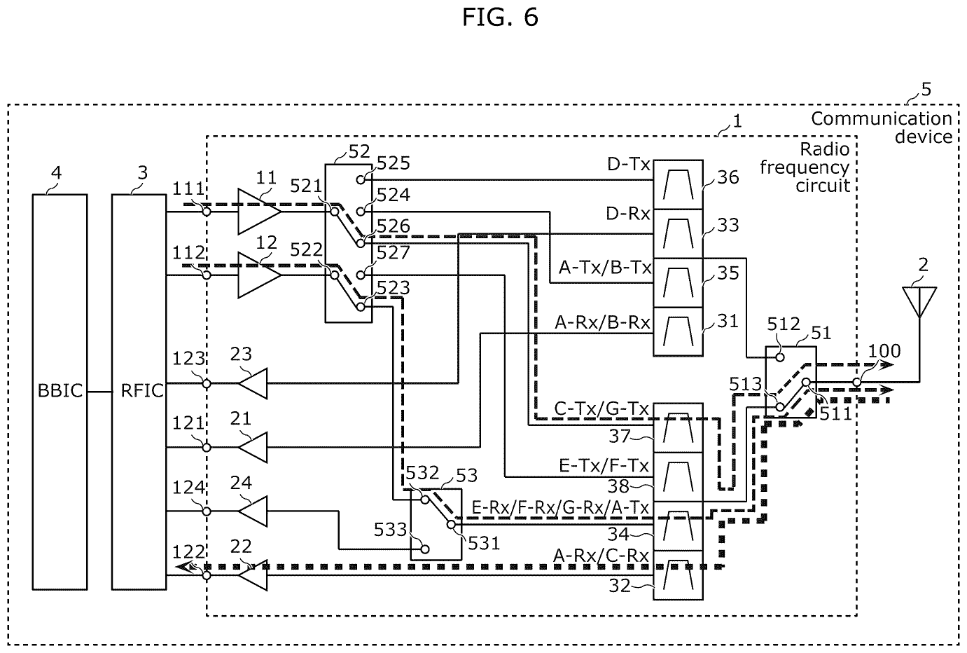

First, simultaneous communication in Band Combination 4 of Bands A and C is to be described with reference to FIG. 6. FIG. 6 illustrates a circuit configuration showing a connected state for simultaneous communication in Bands A and C in the present embodiment. In FIG. 6, broken line arrows show flows of radio frequency signals.

In the connected state in FIG. 6, switch 51 connects terminal 511 to terminal 513 and not to terminal 512. Switch 52 connects terminal 521 to terminal 526 and connects terminal 522 to terminal 523. Switch 53 connects terminal 531 to terminal 532. Accordingly, filters 32, 34, and 37 are connected to antenna connection terminal 100, and filters 34 and 37 are connected to power amplifiers 12 and 11, respectively.

As a result, received signals in Bands A and C are transferred from antenna 2 to RFIC 3 via antenna connection terminal 100, switch 51, filter 32, low-noise amplifier 22, and radio frequency output terminal 122. A transmission signal in Band A is transferred from RFIC 3 to antenna 2 via radio frequency input terminal 112, power amplifier 12, switches 52 and 53, filter 34, switch 51, and antenna connection terminal 100. A transmission signal in Band C is transferred from RFIC 3 to antenna 2 via radio frequency input terminal 111, power amplifier 11, switch 52, filter 37, switch 51, and antenna connection terminal 100.

### 1.5 Advantageous Effects and Others

As described above, radio frequency circuit 1 according to the present embodiment includes: filter 31 having a passband that includes a downlink band of Band A and a downlink band of Band B; filter 32 having a passband that includes the downlink band of Band A and a downlink band of Band C; and switch 51 that includes terminal 511 connected to antenna connection terminal 100, terminal 512 connected to filter 31, and terminal 513 connected to filter 32. The downlink band of Band A, the downlink band of Band B, and the downlink band of Band C at least partially overlap one another, and a combination of Band A and Band B and a combination of Band A and Band C are included in predefined band combinations for simultaneous communication.

According to this, simultaneous communication (downlink communication) in a combination of Bands A and B can be supported by filter 31, and simultaneous communication (downlink communication) in a combination of Bands A and C can be supported by filter 32. Thus, the number of filters can be decreased as compared to the case in which separate three filters are included for Bands A to C, which can contribute to reduction in the size of communication device 5. Furthermore, in the band combinations, switch 51 may simply connect terminal 511 to one of terminal 512 or 513, and thus loss due to impedance mismatching, for instance, can be more reduced than the case in which a plurality of terminals are connected to terminal 511. Filter 31 for receiving signals in Bands A and B and filter 32 for receiving signals in Bands A and C are connected to different terminals 512 and 513 of switch 51, respectively. Thus, a path for a downlink signal for a band combination that includes Band B and a path for a downlink signal for a band combination that includes Band C can be separated by switch 51, and it is possible to support simultaneous communication in a wider variety of band combinations than a case in which a single filter for downlink communication in Bands A to C.

For example, radio frequency circuit 1 according to the present embodiment may further include: filter 33 connected to terminal 512 of switch 51 and having a passband that includes a downlink band of Band D; and filter 34 connected to terminal 513 of switch 51 and having a passband that includes a downlink band of Band E. A combination of Band B and Band D and a combination of Band C and Band E may be included in the predefined band combinations for simultaneous communication.

According to this, in addition to a combination of Bands A and B and a combination of Bands A and C, simultaneous communication (downlink communication) in a combination of Bands B and D and a combination of Bands C and E can be supported.

For example, radio frequency circuit 1 according to the present embodiment may further include: filter 35 connected to terminal 512 of switch 51 and having a passband that includes an uplink band of Band B. The uplink band of Band B at least partially overlaps the downlink band of Band E.

According to this, filter 35 having a passband that includes the uplink band of Band B and filter 34 having a passband that includes the downlink band of Band E that at least partially overlaps the uplink band of Band B are connected to different terminals 512 and 513 of switch 51, respectively. Thus, filter 34 can be prevented from being connected to a path for an uplink signal in Band B, and filter 35 can be prevented from being connected to a path for a downlink signal in Band E. Accordingly, it is possible to support simultaneous communication in a combination of Bands A and B, a combination of Bands A and C, a combination of Bands B and D, and a combination of Bands C and E, so that simultaneous communication in a wider variety of combinations can be supported.

For example, in radio frequency circuit 1 according to the present embodiment, switch 51 may be configured to connect terminal 511 exclusively to terminal 512 or to connect terminal 511 exclusively to terminal 513.

According to this, under a condition that terminal 511 of switch 51 is connected to terminal 512, terminal 511 is not connected to terminal 513, and thus the isolation between filters 34 and 35 can be ensured from each other, and thus simultaneous transmission and reception in a combination of Bands B and D can be supported.

According to this, terminal 511 can be prevented from being simultaneously connected to terminals 512 and 513. Thus, the isolation between a filter connected to terminal 512 and a filter connected to terminal 513, or in particular, the isolation between filters 34 and 35 can be ensured, and it is possible to support simultaneous communication in a wider variety of band combinations.

For example, in radio frequency circuit 1 according to the present embodiment, in simultaneous communication in Band A and Band B and simultaneous communication in Band B and Band D, switch 51 may be configured to connect terminal 511 to terminal 512 and not to connect terminal 511 to terminal 513.

According to this, in simultaneous communication in Bands A and B and simultaneous communication in Bands B and D, filters 32 and 34 can be disconnected from communication paths, and quality of simultaneous communication in Bands A and B and simultaneous communication in Bands B and D can be improved.

For example, in radio frequency circuit 1 according to the present embodiment, in simultaneous communication in Band A and Band C and simultaneous communication in Band C and Band E, switch 51 may be configured to connect terminal 511 to terminal 513 and not to connect terminal 511 to terminal 512.

According to this, in simultaneous communication in Bands A and C and simultaneous communication in Bands C and E, filters 31, 33, and 35 can be disconnected from communication paths, and quality of simultaneous communication in Bands A and C and simultaneous communication in Bands C and E can be improved.

For example, in radio frequency circuit 1 according to the present embodiment, an uplink band of Band A may at least partially overlap the uplink band of Band B and the downlink band of Band E, the passband of filter 34 and the passband of filter 35 may each further include the uplink band of Band A, and radio frequency circuit 1 may further include: filter 36 connected to terminal 512 of switch 51 and having a passband that includes an uplink band of Band D; filter 37 connected to terminal 513 of switch 51 and having a passband that includes an uplink band of Band C; and filter 38 connected to terminal 513 of switch 51 and having a passband that includes an uplink band of Band E.

According to this, a combination (filters 31, 33, 35, and 36) of (i) filters for Bands A and D that are combined with Band B for simultaneous communication and (ii) filters for Band B can be connected to one terminal 512 of switch 51. Furthermore, a combination (filters 32, 34, 37, and 38) of (i) filters for Bands A and E that are combined with Band C for simultaneous communication and (ii) filters for Band C can be connected to one terminal 513 of switch 51. Thus, communication paths can be switched for the band combination that includes Band B and the band combination that includes Band C, and quality of simultaneous communication can be improved.

For example, radio frequency circuit 1 according to the present embodiment may further include: power amplifier 11; power amplifier 12; low-noise amplifier 21 connected to filter 31; low-noise amplifier 22 connected to filter 32; low-noise amplifier 23 connected to filter 33; low-noise amplifier 24; switch 52 that includes terminal 521 connected to power amplifier 11, terminal 522 connected to power amplifier 12, terminal 523, terminal 524 connected to filter 35, terminal 525 connected to filter 36, terminal 526 connected to filter 37, and terminal 527 connected to filter 38; and switch 53 that includes terminal 531 connected to filter 34, terminal 532 connected to terminal 523 of switch 52, and terminal 533 connected to low-noise amplifier 24.

According to this, in simultaneous communication in the band combinations, radio frequency circuit 1 can amplify uplink signals and downlink signals.

For example, in radio frequency circuit 1 according to the present embodiment, in simultaneous communication in Band B and Band D, switch 51 may be configured to connect terminal 511 to terminal 512 and not to connect terminal 511 to terminal 513, and switch 52 may be configured to connect terminal 521 to terminal 525 and connect terminal 522 to terminal 524.

According to this, in simultaneous communication in Bands B and D, filters 32, 34, 37, and 38 can be disconnected from communication paths, and quality of simultaneous communication in Bands B and D can be improved.

For example, in radio frequency circuit 1 according to the present embodiment, in simultaneous communication in Band A and Band B, switch 51 may be configured to connect terminal 511 to terminal 512 and not to connect terminal 511 to terminal 513, and switch 52 may be configured to connect terminal 522 to terminal 524.

According to this, in simultaneous communication in Bands A and B, filters 32, 34, 37, and 38 can be disconnected from communication paths, and quality of simultaneous communication in Bands A and B can be improved.

For example, in radio frequency circuit 1 according to the present embodiment, in simultaneous communication in Band C and Band E, switch 51 may be configured to connect terminal 511 to terminal 513 and not to connect terminal 511 to terminal 512, switch 52 may be configured to connect terminal 521 to terminal 526 and connect terminal 522 to terminal 527, and switch 53 may be configured to connect terminal 531 to terminal 533.

According to this, in simultaneous communication in Bands C and E, filters 31, 33, 35, and 36 can be disconnected from communication paths, and quality of simultaneous communication in Bands C and E can be improved.

For example, in radio frequency circuit 1 according to the present embodiment, in simultaneous communication in Band A and Band C, switch 51 may be configured to connect terminal 511 to terminal 513 and not to connect terminal 511 to terminal 512, switch 52 may be configured to connect terminal 521 to terminal 526 and connect terminal 522 to terminal 523, and switch 53 may be configured to connect terminal 531 to terminal 532.

According to this, in simultaneous communication in Bands A and C, filters 31, 33, 35, and 36 can be disconnected from communication paths, and quality of simultaneous communication in Bands A and C can be improved.

For example, in radio frequency circuit 1 according to the present embodiment, the downlink band of Band E may overlap a downlink band of Band F and a downlink band of Band G, the uplink band of Band C may at least partially overlap an uplink band of Band G, the uplink band of Band E may at least partially overlap an uplink band of Band F, the passband of filter 34 may further include the downlink band of Band F and the downlink band of Band G, the passband of filter 37 may further include the uplink band of Band G, and the passband of filter 38 may further include the uplink band of Band F.

According to this, it is possible to support simultaneous communication in a combination of Bands C and G and/or a combination of Bands C and F.

For example, in radio frequency circuit 1 according to the present embodiment, Band A may be n256 for 5th Generation New Radio (5G NR), Band B may be Band 1 for Long Term Evolution (LTE) or n1 for 5G NR, Band C may be Band 66 for LTE or n66 for 5G NR, Band D may be Band 3 for LTE or n3 for 5G NR, Band E may be Band 2 for LTE or n2 for 5G NR, Band F may be Band 25 for LTE or n25 for 5G NR, and Band G may be Band 70 for LTE or n70 for 5G NR.

According to this, radio frequency circuit 1 can be utilized in a 5G NR system and/or an LTE system.

From another point of view, radio frequency circuit 1 according to the present embodiment includes: filter 31 having a passband that includes a downlink band of n256 for 5th Generation New Radio (5G NR) and a downlink band of Band 1 for Long Term Evolution (LTE) or n1 for 5G NR; filter 32 having a passband that includes the downlink band of n256 for 5G NR and a downlink band of Band 66 for LTE or n66 for 5G NR; filter 33 having a passband that includes a downlink band of Band 3 for LTE or n3 for 5G NR; filter 34 having a passband that includes a downlink band of Band 2 for LTE or n2 for 5G NR and an uplink band of n256 for 5G NR; filter 35 having a passband that includes the uplink band of n256 for 5G NR and an uplink band of Band 1 for LTE or n1 for 5G NR; filter 36 having a passband that includes an uplink band of Band 3 for LTE or n3 for 5G NR; filter 37 having a passband that includes an uplink band of Band 66 for LTE or n66 for 5G NR; filter 38 connected to terminal 513 of switch 51 and having a passband that includes an uplink band of Band 2 for LTE or n2 for 5G NR; and switch 51 that includes terminal 511 connected to antenna connection terminal 100, terminal 512 connected to filter 31, filter 33, filter 35, and filter 36, and terminal 513 connected to filter 32, filter 34, filter 37, and filter 38.

According to this, simultaneous communication (downlink communication) in a combination of n256 and Band 1 or n1 can be supported by filter 31, and simultaneous communication (downlink communication) in a combination of n256 and Band 66 or n66 can be supported by filter 32. Thus, the number of filters can be decreased as compared to the case in which separate three filters are included for n256, Band 1 or n1, and Band 66 or n66, which can contribute to reduction in the size of communication device 5. Furthermore, switch 51 may connect terminal 511 to one of terminal 512 or 513 in each of a combination of n256 and Band 1 or n1, a combination of n256 and Band 66 or n66, a combination of Band 1 or n1 and Band 3 or n3, and a combination of Band 66 or n66 and Band 2 or n2, and thus loss due to impedance mismatching, for instance, can be more reduced than the case in which a plurality of terminals are connected to terminal 511. Filter 35 for uplink communication in Band 1 or n1 and filter 34 for downlink communication in Band 2 or n2 are connected to different terminals 512 and 513 of switch 51. Thus, filter 34 can be prevented from being connected to a path for an uplink signal in Band 1 or n1 in a band combination that includes Band 1 or n1, and filter 35 can be prevented from being connected to a path for a downlink signal in Band 2 or n2 in a band combination that includes Band 2 or n2. Accordingly, it is possible to support simultaneous communication in a combination of n256 and Band 1 or n1, a combination of n256 and Band 66 or n66, a combination of Band 1 or n1 and Band 3 or n3, and a combination of Band 66 or n66 and Band 2 or n2, so that simultaneous communication in a wider variation of band combinations can be supported.

For example, radio frequency circuit 1 according to the present embodiment may further include: power amplifier 11; power amplifier 12; low-noise amplifier 21 connected to filter 31; low-noise amplifier 22 connected to filter 32; low-noise amplifier 23 connected to filter 33; low-noise amplifier 24; switch 52 that includes terminal 521 connected to power amplifier 11, terminal 522 connected to power amplifier 12, terminal 523, terminal 524 connected to filter 35, terminal 525 connected to filter 36, terminal 526 connected to filter 37, and terminal 527 connected to filter 38; and switch 53 that includes terminal 531 connected to filter 34, terminal 532 connected to terminal 523 of switch 52, and terminal 533 connected to low-noise amplifier 24.

According to this, radio frequency circuit 1 can amplify uplink signals and downlink signals in simultaneous communication in the band combinations.

For example, in radio frequency circuit 1 according to the present embodiment, the passband of filter 34 may further include a downlink band of Band 25 for LTE or n25 for 5G NR and a downlink band of Band 70 for LTE or n70 for 5G NR, the passband of filter 37 may further include an uplink band of Band 70 for LTE or n70 for 5G NR, and the passband of filter 38 may further include an uplink band of Band 25 for LTE or n25 for 5G NR.

According to this, it is possible to support simultaneous communication in a combination of Band 66 or n66 and Band 25 or n25 and/or a combination of Band 66 or n66 and Band 70 or n70.

### Other Embodiments

The above has described radio frequency circuits according to the present disclosure, based on the embodiment, yet the radio frequency circuits according to the present disclosure are not limited to the above embodiment. The scope of the present disclosure encompasses variations resulting from applying, to the embodiment, various modifications that may be conceived by those skilled in the art within a range that does not depart from the scope of the present disclosure or various devices that include radio frequency circuits as described above.

For example, in the circuit configuration of radio frequency circuit 1 according to the above embodiments, another circuit element and a line, for instance, may be provided between circuit elements and paths connecting signal paths, which are disclosed in the drawings. For example, an impedance matching circuit may be provided between power amplifier 11 and at least one of filters 34 to 38. For example, an impedance matching circuit may be provided between at least one of filters 31 to 38 and antenna connection terminal 100. An impedance matching circuit can be provided with an inductor and/or a capacitor, for example, but is not limited to such a configuration.

Note that in the above embodiment, radio frequency circuit 1 includes transmission paths, but the configuration is not limited thereto. Thus, radio frequency circuit 1 may at least include a reception path and may not include transmission paths. Conversely, under a condition that communication device 5 that includes radio frequency circuit 1 is utilized as a base station (BS), the power amplifiers may be replaced with low-noise amplifiers, and the low-noise amplifiers may be replaced with power amplifiers. In this case, radio frequency circuit 1 may not include reception paths.

Note that in the above embodiments, n256, Band 1 or n1, and Band 66 or n66 are used as Bands A to C, but Bands A to C are not limited to these. For example, as Band A, instead of n256, Band 1 or n1 may be used, Band 66 or n66 may be used, or Band 4 for LTE (UL: 2110 MHz to 2155 MHZ, DL: 1710 MHz to 1785 MHZ) may be used. For example, as band B, instead of Band 1 or n1, n256 may be used, Band 66 or n66 may be used, or Band 4 may be used. For example, as Band C, n256 may be used, Band 1 or n1 may be used, or Band 4 may be used, instead of Band 66 or n66. Thus, combinations of Bands A to C may be any three combinations among the combinations of n256, Band 1 or n1, Band 66 or n66, and Band 4. In such a case, advantageous effects similar to those yielded by the above embodiment can be yielded.

Similarly, for example, Band 41 for LTE or n41 or 5G NR may be used as Band A. In this case, a combination of n254 for 5G NR and Band 53 for LTE or n53 for 5G NR may be used as a combination of Bands B and C.

For example, Bands A to C are not limited to FDD bands for which different frequency bands are used as a transmission band and a receiving band, and may be time division duplex (TDD) bands for which the same frequency band is used. Specifically, n77 or n78 for 5G NR may be used as Band A. In this case, as a combination of Bands B and C, a combination of Band 42 for LTE and Band 48 for LTE or n48 for 5G NR may be used.

The following states features of the radio frequency circuits described based on the above embodiment.

<1>

A radio frequency circuit including:
a first filter having a passband that includes a downlink band of a first band and a downlink band of a second band;
a second filter having a passband that includes the downlink band of the first band and a downlink band of a third band; and
a first switch that includes a first terminal connected to an antenna connection terminal, a second terminal connected to the first filter, and a third terminal connected to the second filter,
wherein the downlink band of the first band, the downlink band of the second band, and the downlink band of the third band at least partially overlap one another, and
a combination of the first band and the second band and a combination of the first band and the third band are included in predefined band combinations for simultaneous communication.
   <2>

The radio frequency circuit according to <1>, further including:
a third filter connected to the second terminal of the first switch and having a passband that includes a downlink band of a fourth band; and
a fourth filter connected to the third terminal of the first switch and having a passband that includes a downlink band of a fifth band,
wherein a combination of the second band and the fourth band and a combination of the third band and the fifth band are included in the predefined band combinations for simultaneous communication.
   <3>

The radio frequency circuit according to <2>, further including:
a fifth filter connected to the second terminal of the first switch and having a passband that includes an uplink band of the second band,
wherein the uplink band of the second band at least partially overlaps the downlink band of the fifth band.
   <4>

The radio frequency circuit according to <3>,
wherein the first switch is configured to connect the first terminal exclusively to the second terminal or to connect the first terminal exclusively to the third terminal.
   <5>

The radio frequency circuit according to <4>,
wherein in simultaneous communication in the first band and the second band and simultaneous communication in the second band and the fourth band, the first switch is configured to connect the first terminal to the second terminal and not to connect the first terminal to the third terminal.
   <6>

The radio frequency circuit according to <4> or <5>,
wherein in simultaneous communication in the first band and the third band and simultaneous communication in the third band and the fifth band, the first switch is configured to connect the first terminal to the third terminal and not to connect the first terminal to the second terminal.
   <7>

The radio frequency circuit according to any one of <3> to <6>,
wherein an uplink band of the first band at least partially overlaps the uplink band of the second band and the downlink band of the fifth band,
the passband of the fourth filter and the passband of the fifth filter each further include the uplink band of the first band, and the radio frequency circuit further includes:
   a sixth filter connected to the second terminal of the first switch and having a passband that includes an uplink band of the fourth band;
   a seventh filter connected to the third terminal of the first switch and having a passband that includes an uplink band of the third band; and
   an eighth filter connected to the third terminal of the first switch and having a passband that includes an uplink band of the fifth band.
      <8>

The radio frequency circuit according to <7>, further including:
a first power amplifier;
a second power amplifier;
a first low-noise amplifier connected to the first filter;
a second low-noise amplifier connected to the second filter;
a third low-noise amplifier connected to the third filter;
a fourth low-noise amplifier;
a second switch that includes a fourth terminal connected to the first power amplifier, a fifth terminal connected to the second power amplifier, a sixth terminal, a seventh terminal connected to the fifth filter, an eighth terminal connected to the sixth filter, a ninth terminal connected to the seventh filter, and a tenth terminal connected to the eighth filter; and
a third switch that includes an eleventh terminal connected to the fourth filter, a twelfth terminal connected to the sixth terminal of the second switch, and a thirteenth terminal connected to the fourth low-noise amplifier.
   <9>

The radio frequency circuit according to <8>,
wherein in simultaneous communication in the second band and the fourth band,
   the first switch is configured to connect the first terminal to the second terminal and not to connect the first terminal to the third terminal, and
   the second switch is configured to connect the fourth terminal to the eighth terminal and connect the fifth terminal to the seventh terminal.
      <10>

The radio frequency circuit according to <8> or <9>,
wherein in simultaneous communication in the first band and the second band,
   the first switch is configured to connect the first terminal to the second terminal and not to connect the first terminal to the third terminal, and
   the second switch is configured to connect the fifth terminal to the seventh terminal.
      <11>

The radio frequency circuit according to any one of <8> to <10>,
wherein in simultaneous communication in the third band and the fifth band,
   the first switch is configured to connect the first terminal to the third terminal and not to connect the first terminal to the second terminal,
   the second switch is configured to connect the fourth terminal to the ninth terminal and connect the fifth terminal to the tenth terminal, and
   the third switch is configured to connect the eleventh terminal to the thirteenth terminal.
      <12>

The radio frequency circuit according to any one of <8> to <11>,
wherein in simultaneous communication in the first band and the third band,
   the first switch is configured to connect the first terminal to the third terminal and not to connect the first terminal to the second terminal,
   the second switch is configured to connect the fourth terminal to the ninth terminal and connect the fifth terminal to the sixth terminal, and
   the third switch is configured to connect the eleventh terminal to the twelfth terminal.
      <13>

The radio frequency circuit according to any one of <7> to <12>,
wherein the downlink band of the fifth band overlaps a downlink band of a sixth band and a downlink band of a seventh band,
the uplink band of the third band at least partially overlaps an uplink band of the seventh band,
the uplink band of the fifth band at least partially overlaps an uplink band of the sixth band,
the passband of the fourth filter further includes the downlink band of the sixth band and the downlink band of the seventh band,
the passband of the seventh filter further includes the uplink band of the seventh band, and
the passband of the eighth filter further includes the uplink band of the sixth band.
   <14>

The radio frequency circuit according to <13>,
wherein the first band is n256 for 5th Generation New Radio (5G NR),
the second band is Band 1 for Long Term Evolution (LTE) or n1 for 5G NR,
the third band is Band 66 for LTE or n66 for 5G NR,
the fourth band is Band 3 for LTE or n3 for 5G NR,
the fifth band is Band 2 for LTE or n2 for 5G NR,
the sixth band is Band 25 for LTE or n25 for 5G NR, and
the seventh band is Band 70 for LTE or n70 for 5G NR.
   <15>

A radio frequency circuit including:
a first filter having a passband that includes a downlink band of n256 for 5th Generation New Radio (5G NR) and a downlink band of Band 1 for Long Term Evolution (LTE) or n1 for 5G NR;
a second filter having a passband that includes the downlink band of n256 for 5G NR and a downlink band of Band 66 for LTE or n66 for 5G NR;
a third filter having a passband that includes a downlink band of Band 3 for LTE or n3 for 5G NR;
a fourth filter having a passband that includes a downlink band of Band 2 for LTE or n2 for 5G NR and an uplink band of n256 for 5G NR;
a fifth filter having a passband that includes the uplink band of n256 for 5G NR and an uplink band of Band 1 for LTE or n1 for 5G NR;
a sixth filter having a passband that includes an uplink band of Band 3 for LTE or n3 for 5G NR;
a seventh filter having a passband that includes an uplink band of Band 66 for LTE or n66 for 5G NR;
an eighth filter having a passband that includes an uplink band of Band 2 for LTE or n2 for 5G NR; and
a first switch that includes a first terminal connected to an antenna connection terminal, a second terminal connected to the first filter, the third filter, the fifth filter, and the sixth filter, and a third terminal connected to the second filter, the fourth filter, the seventh filter, and the eighth filter.
   <16>

The radio frequency circuit according to <15>, further including:
a first power amplifier;
a second power amplifier;
a first low-noise amplifier connected to the first filter;
a second low-noise amplifier connected to the second filter;
a third low-noise amplifier connected to the third filter;
a fourth low-noise amplifier;
a second switch that includes a fourth terminal connected to the first power amplifier, a fifth terminal connected to the second power amplifier, a sixth terminal, a seventh terminal connected to the fifth filter, an eighth terminal connected to the sixth filter, a ninth terminal connected to the seventh filter, and a tenth terminal connected to the eighth filter; and
a third switch that includes an eleventh terminal connected to the fourth filter, a twelfth terminal connected to the sixth terminal of the second switch, and a thirteenth terminal connected to the fourth low-noise amplifier.
   <17>

The radio frequency circuit according to <15> or <16>,
wherein the passband of the fourth filter further includes a downlink band of Band 25 for LTE or n25 for 5G NR and a downlink band of Band 70 for LTE or n70 for 5G NR,
the passband of the seventh filter further includes an uplink band of Band 70 for LTE or n70 for 5G NR, and
the passband of the eighth filter further includes an uplink band of Band 25 for LTE or n25 for 5G NR.
   <18>

A radio frequency circuit including:
a first filter having a passband that includes a downlink band of a first band and a downlink band of a second band;
a second filter having a passband that includes the downlink band of the first band and a downlink band of a third band; and
a first switch that includes a first terminal connected to an antenna connection terminal, a second terminal connected to the first filter, and a third terminal connected to the second filter,
wherein a combination of the first band and the second band and a combination of the first band and the third band are included in predefined band combinations for simultaneous communication, and
combinations of the first band, the second band, and the third band are three combinations among combinations of n256 for 5G NR, Band 1 for LTE or n1 for 5G NR, Band 66 for LTE or n66 for 5G NR, and Band 4 for LTE.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely applicable to communication devices such as mobile phones as radio frequency circuits disposed in front end portions.

1. A radio frequency circuit comprising:
a first filter having a passband that includes a downlink band of a first band and a downlink band of a second band;
a second filter having a passband that includes the downlink band of the first band and a downlink band of a third band; and
a first switch that includes a first terminal connected to an antenna connection terminal, a second terminal connected to the first filter, and a third terminal connected to the second filter,
wherein the downlink band of the first band, the downlink band of the second band, and the downlink band of the third band at least partially overlap one another, and
a combination of the first band and the second band is included in a first predefined band combination for simultaneous communication, and a combination of the first band and the third band is included in a second predefined band combination for simultaneous communication.

2. The radio frequency circuit according to claim 1, further comprising:
a third filter connected to the second terminal of the first switch and having a passband that includes a downlink band of a fourth band; and
a fourth filter connected to the third terminal of the first switch and having a passband that includes a downlink band of a fifth band,
wherein a combination of the second band and the fourth band is included in a third predefined band combination for simultaneous communication, and a combination of the third band and the fifth band is included in a fourth predefined band combination for simultaneous communication.

3. The radio frequency circuit according to claim 2, further comprising:
a fifth filter connected to the second terminal of the first switch and having a passband that includes an uplink band of the second band,
wherein the uplink band of the second band at least partially overlaps the downlink band of the fifth band.

4. The radio frequency circuit according to claim 3,
wherein the first switch is configured to connect the first terminal exclusively to the second terminal, or to connect the first terminal exclusively to the third terminal.

5. The radio frequency circuit according to claim 4,
wherein in simultaneous communication in the first band and the second band and in simultaneous communication in the second band and the fourth band, the first switch is configured to connect the first terminal to the second terminal and not connect the first terminal to the third terminal.

6. The radio frequency circuit according to claim 4,
wherein in simultaneous communication in the first band and the third band and in simultaneous communication in the third band and the fifth band, the first switch is configured to connect the first terminal to the third terminal and not connect the first terminal to the second terminal.

7. The radio frequency circuit according to claim 3,
wherein an uplink band of the first band at least partially overlaps the uplink band of the second band and the downlink band of the fifth band,
the passband of the fourth filter and the passband of the fifth filter each further include the uplink band of the first band, and
the radio frequency circuit further comprises:
a sixth filter connected to the second terminal of the first switch and having a passband that includes an uplink band of the fourth band;
a seventh filter connected to the third terminal of the first switch and having a passband that includes an uplink band of the third band; and
an eighth filter connected to the third terminal of the first switch and having a passband that includes an uplink band of the fifth band.

8. The radio frequency circuit according to claim 7, further comprising:
a first power amplifier;
a second power amplifier;
a first low-noise amplifier connected to the first filter;
a second low-noise amplifier connected to the second filter;
a third low-noise amplifier connected to the third filter;
a fourth low-noise amplifier;
a second switch that includes a fourth terminal connected to the first power amplifier, a fifth terminal connected to the second power amplifier, a sixth terminal, a seventh terminal connected to the fifth filter, an eighth terminal connected to the sixth filter, a ninth terminal connected to the seventh filter, and a tenth terminal connected to the eighth filter; and
a third switch that includes an eleventh terminal connected to the fourth filter, a twelfth terminal connected to the sixth terminal of the second switch, and a thirteenth terminal connected to the fourth low-noise amplifier.

9. The radio frequency circuit according to claim 8,
wherein in simultaneous communication in the second band and the fourth band,
the first switch is configured to connect the first terminal to the second terminal and not connect the first terminal to the third terminal, and
the second switch is configured to connect the fourth terminal to the eighth terminal and connect the fifth terminal to the seventh terminal.

10. The radio frequency circuit according to claim 8,
wherein in simultaneous communication in the first band and the second band,
the first switch is configured to connect the first terminal to the second terminal and not connect the first terminal to the third terminal, and
the second switch is configured to connect the fifth terminal to the seventh terminal.

11. The radio frequency circuit according to claim 8,
wherein in simultaneous communication in the third band and the fifth band,
the first switch is configured to connect the first terminal to the third terminal and not connect the first terminal to the second terminal,
the second switch is configured to connect the fourth terminal to the ninth terminal and connect the fifth terminal to the tenth terminal, and
the third switch is configured to connect the eleventh terminal to the thirteenth terminal.

12. The radio frequency circuit according to claim 8,
wherein in simultaneous communication in the first band and the third band,
the first switch is configured to connect the first terminal to the third terminal and not connect the first terminal to the second terminal,
the second switch is configured to connect the fourth terminal to the ninth terminal and connect the fifth terminal to the sixth terminal, and
the third switch is configured to connect the eleventh terminal to the twelfth terminal.

13. The radio frequency circuit according to claim 7,
wherein the downlink band of the fifth band overlaps a downlink band of a sixth band and a downlink band of a seventh band,
the uplink band of the third band at least partially overlaps an uplink band of the seventh band,
the uplink band of the fifth band at least partially overlaps an uplink band of the sixth band,
the passband of the fourth filter further includes the downlink band of the sixth band and the downlink band of the seventh band,
the passband of the seventh filter further includes the uplink band of the seventh band, and
the passband of the eighth filter further includes the uplink band of the sixth band.

14. The radio frequency circuit according to claim 13,
wherein the first band is n256 for 5th Generation New Radio (5G NR),
the second band is Band 1 for Long Term Evolution (LTE) or n1 for 5G NR,
the third band is Band 66 for LTE or n66 for 5G NR,
the fourth band is Band 3 for LTE or n3 for 5G NR,
the fifth band is Band 2 for LTE or n2 for 5G NR,
the sixth band is Band 25 for LTE or n25 for 5G NR, and
the seventh band is Band 70 for LTE or n70 for 5G NR.

15. A radio frequency circuit comprising:
a first filter having a passband that includes a downlink band of n256 for 5th Generation New Radio (5G NR) and a downlink band of Band 1 for Long Term Evolution (LTE) or n1 for 5G NR;
a second filter having a passband that includes the downlink band of n256 for 5G NR and a downlink band of Band 66 for LTE or n66 for 5G NR;
a third filter having a passband that includes a downlink band of Band 3 for LTE or n3 for 5G NR;
a fourth filter having a passband that includes a downlink band of Band 2 for LTE or n2 for 5G NR and an uplink band of n256 for 5G NR;
a fifth filter having a passband that includes the uplink band of n256 for 5G NR and an uplink band of Band 1 for LTE or n1 for 5G NR;
a sixth filter having a passband that includes an uplink band of Band 3 for LTE or n3 for 5G NR;
a seventh filter having a passband that includes an uplink band of Band 66 for LTE or n66 for 5G NR;
an eighth filter having a passband that includes an uplink band of Band 2 for LTE or n2 for 5G NR; and
a first switch that includes a first terminal connected to an antenna connection terminal, a second terminal connected to the first filter, the third filter, the fifth filter, and the sixth filter, and a third terminal connected to the second filter, the fourth filter, the seventh filter, and the eighth filter.

16. The radio frequency circuit according to claim 15, further comprising:
a first power amplifier;
a second power amplifier;
a first low-noise amplifier connected to the first filter;
a second low-noise amplifier connected to the second filter;
a third low-noise amplifier connected to the third filter;
a fourth low-noise amplifier;
a second switch that includes a fourth terminal connected to the first power amplifier, a fifth terminal connected to the second power amplifier, a sixth terminal, a seventh terminal connected to the fifth filter, an eighth terminal connected to the sixth filter, a ninth terminal connected to the seventh filter, and a tenth terminal connected to the eighth filter; and
a third switch that includes an eleventh terminal connected to the fourth filter, a twelfth terminal connected to the sixth terminal of the second switch, and a thirteenth terminal connected to the fourth low-noise amplifier.

17. The radio frequency circuit according to claim 15,
wherein the passband of the fourth filter further includes a downlink band of Band 25 for LTE or n25 for 5G NR and a downlink band of Band 70 for LTE or n70 for 5G NR,
the passband of the seventh filter further includes an uplink band of Band 70 for LTE or n70 for 5G NR, and
the passband of the eighth filter further includes an uplink band of Band 25 for LTE or n25 for 5G NR.

18. A radio frequency circuit comprising:
a first filter having a passband that includes a downlink band of a first band and a downlink band of a second band;
a second filter having a passband that includes the downlink band of the first band and a downlink band of a third band; and
a first switch that includes a first terminal connected to an antenna connection terminal, a second terminal connected to the first filter, and a third terminal connected to the second filter,
wherein a combination of the first band and the second band is included in a first predefined band combination for simultaneous communication, and a combination of the first band and the third band is included in a second predefined band combination for simultaneous communication, and
combinations of the first band, the second band, and the third band are three combinations among combinations of n256 for 5G NR, Band 1 for LTE or n1 for 5G NR, Band 66 for LTE or n66 for 5G NR, and Band 4 for LTE.
